(19) United States
(12) Patent Application Publication
(10) Pub. No.: US 2007/0014118 A1
(43) Pub. Date: Jan. 18, 2007

(54) Light fixture

(76) Inventor: Alvin Shourds, Petersburg, NJ (US)

Correspondence Address: NORMAN E. LEHRER, P.C., 1205 NORTH KINGS HIGHWAY, CHERRY HILL, NJ, 08034, US

(21) Appl. No.: 11/181,593

(22) Filed: Jul. 14, 2005

(51) Int. Cl. F21V 21/16

(52) U.S. Cl. 362/407; 362/147; 362/650

(57) ABSTRACT

A light fixture that converts a recessed light to a hanging light includes the recessed light having a cylindrical housing, an electrical socket formed therein, and a trim ring mounted thereon, the conversion light fixture includes an elongated cord having a first end and a second end, a light secured to the first end of the cord, and an electrical plug secured to the second end of the cord. The plug is adapted to fit into the electrical socket of the recessed light. The cord includes a cover secured adjacent the second end of the cord. The cover may be adapted to fit within the recessed light or over the trim ring of the recessed light. The light fixture also includes a nut secured adjacent the second end of the cord. The nut is adapted to frictionally engage the cord so as to retain the cover against the ceiling.

### BACKGROUND OF THE INVENTION

The present invention is directed toward a light fixture and more particularly, toward a light fixture that facilitates converting a recessed light into a hanging light.

Recessed lighting is a common and aesthetically pleasing feature found in many homes. Typically, the light includes a cylindrical housing mounted above the ceiling. The electrical socket is located within the fixture. A light bulb is secured within the socket and extends downwardly from the housing. A decorative trim ring is added to the outer edge of the housing in order to hide the opening in the ceiling.

Often, however, a homeowner grows tired of the décor in his or her home and desires to make certain changes. A typical feature a person may want to change is the lighting. A problem occurs though if a person has recessed lighting and desires to change to a hanging light. To make this conversion is difficult, if not nearly impossible, without altering the electrical construction of the light.

Not many devices are known that allow for making such light fixture changes. U.S. Pat. No. 4,956,758 to Aubrey et al. does disclose a light mounting apparatus that allows surface mounted light fixtures to replace recessed light fixtures without making changes to the electrical construction of the light. This apparatus, however, does not allow for a recessed light to be converted to a hanging light.

U.S. Pat. No. 4,595,969 to McNair discloses a ceiling lamp mounting apparatus that retrofits a fluorescent lamp into a recessed light fixture. The apparatus is self trimming and self aligning. However, this device merely replaces one type of recessed light fixture with another type of recessed light.

Therefore, a need exists for a light fixture that allows for the conversion of a recessed light to a hanging light that is simple to install, is aesthetically pleasing, and does not require modifying the electronic circuitry of the light fixture.

### SUMMARY OF THE INVENTION

The present invention is designed to overcome the deficiencies of the prior art discussed above. It is an object of the present invention to provide a light fixture that enables the conversion of a recessed light to a hanging light.

It is another object of the present invention to provide a light fixture that enables the conversion of a recessed light to a hanging light without having to alter the electrical system of the light.

It is a further object of the present invention to provide a light fixture that is simple to install and is aesthetically pleasing.

In accordance with the illustrative embodiments demonstrating features and advantages of the present invention, there is provided a light fixture conversion apparatus for converting a recessed light into a hanging light. The recessed light fixture includes a cylindrical housing, an electrical socket formed therein, and a trim ring mounted thereon. The conversion apparatus comprises an elongated cord having a first end and a second end, a light secured to the first end of the cord, and an electrical plug secured to the second end of the cord. The plug is adapted to fit into the electrical socket of the recessed light so that the light is suspended outwardly from the recessed light. The cord includes a cover secured adjacent the second end of the cord. The cover may fit over the trim ring of the recessed light. In an alternative embodiment, the cover may fit within the cylindrical housing of the recessed light fixture. The light fixture conversion apparatus also includes a nut secured adjacent the second end of the cord. The nut is adapted to frictionally engage the cord so as to retain the cover against the ceiling.

Other objects, features, and advantages of the invention will be readily apparent from the following detailed description of the preferred embodiments thereof taken in conjunction with the drawings.

### BRIEF DESCRIPTION OF THE DRAWINGS

For the purpose of illustrating the invention, there is shown in the accompanying drawings forms that are presently preferred; it being understood that the invention is not intended to be limited to the precise arrangements and instrumentalities shown.

FIG. 1 is a front perspective view of the light fixture of the present invention;

FIG. 2 is an exploded view of the light fixture of the present invention;

FIG. 3 is a cross-sectional view taken through line 3-3 of FIG. 1;

FIG. 4 is a cross-sectional view taken through line 4-4 of FIG. 3; and

FIG. 5 is a second embodiment of the light fixture of the present invention.

### DETAILED DESCRIPTION OF THE PREFERRED EMBODIMENTS

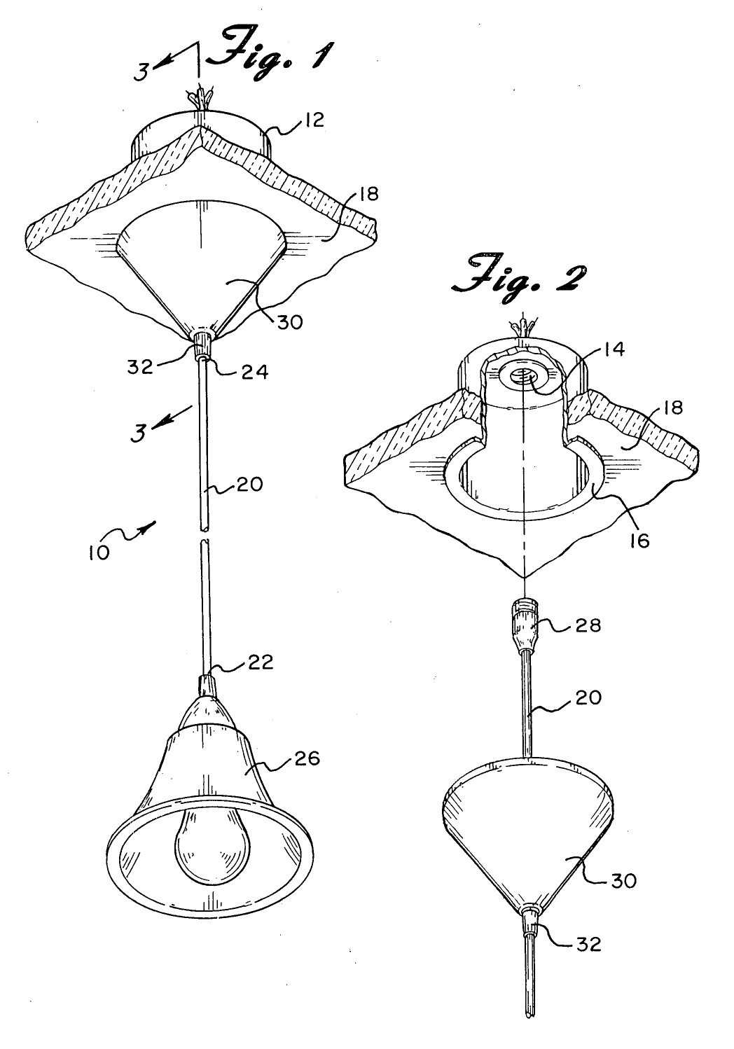

Referring now to the drawings in detail wherein like reference numerals have been used throughout the various figures to designate like elements, there is shown in FIG. 1 a light fixture conversion apparatus constructed in accordance with the principles of the present invention and designated generally as 10.

The present invention includes a light fixture conversion apparatus for converting a recessed light fixture into a hanging light. A typical recessed light fixture, as shown in FIG. 2, includes a cylindrical housing 12, an electrical socket 14 formed therein, and a trim ring 16 mounted thereon. The trim ring 16 engages the ceiling 18.

The conversion apparatus of the present invention includes an elongated cord 20 having a first end 22 and a second end 24. A light 26 is secured to the first end 22 of the cord 20 and an electrical plug 28 is secured to the second end 24 of the cord 20. The plug 28 is essentially in the form of an incandescent light bulb base and is adapted to screw into the electrical socket 14 of the recessed light fixture. (See FIG. 2.) It is possible, however, to include a transformer or the like into the body of the plug 28 for powering a fluorescent light in lieu of the incandescent light 26 shown in the drawings.

The cord 20 also includes a cover 30 secured adjacent the second end 24 of the cord 20. The purpose of the cover will be discussed in greater detail below. The cover may be conical, as shown in the figures. Alternatively, the cover may have more of a flat or dome-shaped appearance or may have essentially any desired shape and appearance.

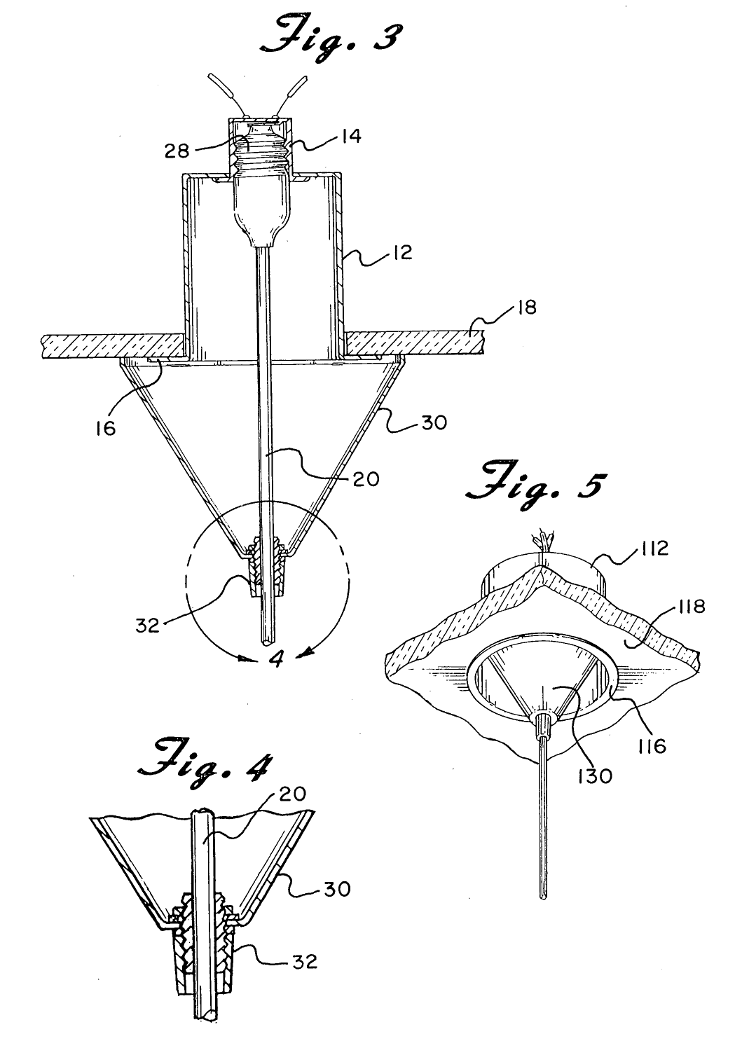

The conversion apparatus of the present invention also includes a nut 32 secured adjacent the second end 24 of the cord 20. The nut 32 is adapted to frictionally engage the cord 20 so as to retain the cover 30 against the ceiling 18. (See FIG. 4.) In this embodiment the cover 30 fits over the trim ring 16 of the recessed light so as to totally hide the same. (See FIG. 3.)

In order to install the light apparatus, the plug 28 of the cord 20 is mounted into the electrical socket 14 of the recessed light fixture. The cover 30 frictionally engages the trim ring 16 and is held in place by screwing or otherwise securing the nut 32 on to the cord 20 against the cover 30. The light 26 is suspended outwardly from the recessed light fixture and hangs downwardly from the ceiling 16. (See FIG. 1.) In this manner, all parts of the recessed light fixture are hidden from view, thereby providing an aesthetically pleasing appearance.

A second embodiment is shown in FIG. 5. The conversion apparatus in this embodiment functions in the same manner as the conversion apparatus in the first embodiment. However, in this embodiment the cover 130 may fit within the cylindrical housing 112 of the recessed light fixture, above the ceiling 118. The trim ring 116 is exposed. The light is suspended downwardly from the recessed light fixture. While all of the various parts of the recessed light fixture may not be hidden from view in this embodiment, the overall appearance is still attractive.

While the invention has been described as allowing a homeowner to change the decor of his or her home by converting recessed lighting to hanging lighting, it should be readily apparent that this conversion is not permanent. At any time, the homeowner can go back to the recessed lighting by simply lowering the cover and unscrewing the plug. Furthermore, the present invention may be used for temporary decorative purposes. That is, during certain holiday periods such as Halloween, lights 26 in the shape of jack-o-lanterns or the like can be utilized. In this way, a room can be decorated with hanging jack-o-lanterns without having to replace lighting fixtures. After the holiday, the hanging light fixture 10 can then be removed.

The present invention may be embodied in other specific forms without departing from the spirit or essential attributes thereof and accordingly, reference should be made to the appended claims rather than to the foregoing specification as indicating the scope of the invention.

I claim:

1. A light fixture conversion apparatus for converting a recessed light into a hanging light, the recessed light fixture having a cylindrical housing, an electrical socket formed therein, and a trim ring mounted thereon, the conversion apparatus comprising:
an elongated cord having a first end and a second end;
a light secured to said first end of said cord;
an electrical plug with a screw base secured to said second end of said cord; and
a cover secured adjacent said second end of said cord,
wherein said plug is adapted to be screwed into the electrical socket of the recessed light fixture and said light is suspended downwardly from the recessed light fixture.

2. The light fixture conversion apparatus of claim 1 wherein said cover is adapted to fit over the trim ring of the recessed light fixture.

3. The light fixture conversion apparatus of claim 2 further including a nut secured adjacent said second end of said cord, said nut being adapted to frictionally engage said cord so as to retain said cover against the ceiling.

4. The light fixture conversion apparatus of claim 1 wherein said cover is adapted to fit within the recessed light fixture.
